(19) United States
(12) Patent Application Publication
(10) Pub. No.: US 2026/0164316 A1
(43) Pub. Date: Jun. 11, 2026

(54) COMMUNICATION METHOD AND COMMUNICATION DEVICE

(71) Applicant: TOYOTA JIDOSHA KABUSHIKI KAISHA, Toyota-shi (JP)

(72) Inventors: Jing MA, Tokyo (JP); Lei ZHONG, Tokyo (JP)

(73) Assignee: TOYOTA JIDOSHA KABUSHIKI KAISHA, Toyota-shi (JP)

(21) Appl. No.: 19/405,821

(22) Filed: Dec. 2, 2025

(30) Foreign Application Priority Data
Dec. 5, 2024 (JP) 2024-212402

(51) Int. Cl. H04W 36/00

(52) U.S. Cl. CPC H04W 36/0055

(57) ABSTRACT

A communication method to be executed by a first access point included in a plurality of access points in a communication system in which a user device is configured to perform communication with the plurality of access points, includes transmitting a first control signal for controlling communication with the user device in a first frequency band, performing data communication with the user device in the first frequency band, and transmitting, in the second frequency band during the data communication with the user device, a second control signal which is a signal requesting one or more other access points to stop transmission of the first control signal. The user device is a moving user device.

### CROSS-REFERENCE TO RELATED APPLICATION

This application claims priority to Japanese Patent Application No. 2024-212402 filed on Dec. 5, 2024. The disclosure of the above-identified application, including the specification, drawings, and claims, is incorporated by reference herein in its entirety.

### BACKGROUND

### 1. Technical Field

The present disclosure relates to a wireless communication method and a wireless communication device.

### 2. Description of Related Art

There is a technique for performing handover of a user terminal among a plurality of access points in a wireless LAN environment (for example, Japanese Unexamined Patent Application Publication No. 2023-171664 (JP 2023-171664 A), and “Wi-Fi Easy Mesh”, [online], Wi-Fi Alliance, [retrieved on Nov. 19, 2024], Internet <URL: https://www.wi-fi.org/ja/discover-wi-fi/wi-fi-easymesh>).

### SUMMARY

The present disclosure improves performance of communication in a wireless communication system including a plurality of access points.

A first aspect of the present disclosure is a communication method to be executed by a first access point included in a plurality of access points in a communication system in which a user device is configured to perform communication with the plurality of access points. The user device is a moving user device The communication method includes transmitting a first control signal for controlling communication with the user device in a first frequency band, performing data communication with the user device in the first frequency band, and transmitting, in a second frequency band during the data communication with the user device, a second control signal which is a signal requesting one or more other access points to stop transmission of the first control signal.

In the communication method according to the first aspect of the present disclosure, the first access point may be configured to successively transmit the second control signal during the data communication with the user device.

The communication method according to the first aspect of the present disclosure may further include stopping the transmission of the first control signal when the first access point receives the second control signal transmitted from one or more other access points. The first control signal may include a signal to be periodically transmitted to find the user device.

In the communication method according to the first aspect of the present disclosure, the second frequency band may be a frequency band with a wider communication possible range than a communication possible range of the first frequency band.

In the communication method according to the first aspect of the present disclosure, the second control signal may be a non-modulated signal.

In the communication method according to the first aspect of the present disclosure, the communication system may be a communication system in which handover is possible. The second frequency band may be a frequency band for sharing information regarding the user device targeted for the handover with one or more other access points belonging to the same group.

The communication method according to the first aspect of the present disclosure may further include transmitting a third control signal which is a signal for sharing information regarding the user device targeted for handover with one or more other access points, in the second frequency band. The communication system may be a communication system in which handover is possible.

A second aspect of the present disclosure is a communication device functioning as a first access point in a communication system in which a user device is configured to perform communication with a plurality of access points. The user device is a moving user device. The communication device includes a control unit. The control unit is configured to transmit a first control signal for controlling communication with the user device in a first frequency band, perform data communication with the user device in the first frequency band, and transmit, in a second frequency band during the data communication with the user device, a second control signal which is a signal requesting one or more other access points to stop transmission of the first control signal.

In the communication device according to the second aspect of the present disclosure, the control unit may be configured to successively transmit the second control signal during the data communication with the user device.

In the communication device according to the second aspect of the present disclosure, the first control signal may include a signal to be periodically transmitted to find the user device, and the control unit may be configured to stop the transmission of the first control signal when the second control signal transmitted from one or more other access points is being received.

In the communication device according to the second aspect of the present disclosure, the second frequency band may be a frequency band with a wider communication possible range than a communication possible range of the first frequency band.

In the communication device according to the second aspect of the present disclosure, the second control signal may be a non-modulated signal.

In the communication device according to the second aspect of the present disclosure, the communication system may be a communication system in which handover is possible. The second frequency band may be a frequency band for sharing information regarding the user device targeted for the handover with one or more other access points belonging to the same group.

In the communication device according to the second aspect of the present disclosure, the communication system may be a communication system in which handover is possible. The control unit may be configured to transmit a third control signal which is a signal for sharing information regarding the user device targeted for the handover with one or more other access points, in the second frequency band.

Further, another aspect includes a device that executes the above-described method, a program for causing a computer to execute the method, or a computer-readable storage medium storing the program in a non-transitory manner.

According to the present disclosure, it is possible to improve performance of communication in a wireless communication system including a plurality of access points.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view for describing a communication system according to an embodiment;

FIG. 2 is a hardware configuration diagram of an in-vehicle device according to the embodiment;

FIG. 3 is a hardware configuration diagram of a roadside device according to the embodiment;

FIG. 4 is a software configuration diagram of the in-vehicle device according to the embodiment;

FIG. 5 is a software configuration diagram of the roadside device according to the embodiment;

FIG. 6 is a flowchart for describing phases to be executed by each device;

FIG. 7 is a sequence diagram indicating flow of data in a connection phase and a transmission/reception phase; and

FIG. 8 is a sequence diagram indicating flow of data in a handover phase.

### DETAILED DESCRIPTION OF EMBODIMENTS

There is a system in which a user terminal can perform handover among a plurality of access points in a wireless LAN environment such as Wi-Fi (registered trademark). In the system, for example, a result of authenticating the user terminal is shared among the plurality of access points. By this means, even when the user terminal moves and an access point that is a connection destination is changed, an authentication phase can be omitted, so that it is possible to perform reconnection in a short period of time.

Further, there is movement to try to apply a communication scheme using Wi-Fi to a mobile body that moves at a high speed. For example, by arranging a plurality of access points along an arterial road and enabling handover, it is possible to implement mobile communication at low cost.

A Wi-Fi access point typically transmits two types of frames, that is, a control frame for controlling communication with the user terminal and a frame for data communication. However, when a plurality of Wi-Fi access points is arranged at short intervals, there is a possibility that a problem may occur that a frame for data communication transmitted by a certain access point interferes with a frame for control transmitted by the adjacent access point, and an error rate increases or a data communication speed decreases.

A communication method according to the present disclosure solves such a problem.

A communication method according to an aspect of the present disclosure is a communication method to be executed by a first access point included in a plurality of access points in a communication system in which a moving user device performs communication with the plurality of access points, the communication method including transmitting a first control signal for controlling communication with the user device in a first frequency band, performing data communication with the user device in the first frequency band, and transmitting a second control signal that is a signal requesting other access points to stop transmission of the first control signal in a second frequency band during the data communication with the user device.

The first access point is one of the plurality of access points that can perform communication with the moving user device. The plurality of access points may be, for example, a plurality of roadside devices provided at predetermined intervals along a road.

The first access point transmits/receives a control frame (first control signal) for controlling communication with the user device and a data frame in the first frequency band.

On the other hand, when the plurality of access points is arranged close to each other, a problem can occur that the control frame interferes with the data frame. For example, while the first access point is performing data communication with the user device, a control frame (first control signal) transmitted from an adjacent second access point can interfere.

To solve this problem, the first access point transmits a second control signal that is a signal requesting other access points to stop transmission of the first control signal in the second frequency band during the data communication with the user device.

The first access point may successively transmit the second control signal during the data communication with the user device. Other access points stop transmission of the first control signal during a period in which the second control signal is being received.

The second frequency band is, for example, a frequency band for sharing information among the plurality of access points belonging to the same group and is a sub-frequency band different from a frequency band (first frequency band) in which main data communication is performed with the user device.

Typically, the first frequency band is a frequency band lower than the second frequency band. For example, when the second frequency band is a gigahertz band, the first frequency band can be set as a megahertz band.

Transmission of the second control signal is stopped, for example, at a timing at which the first access point ends communication with the user device.

Such a configuration makes it possible to reduce radio wave interference between adjacent access points. Particularly, an instruction to stop transmission of the first control signal is given by utilizing a frequency band different from the frequency band in which data communication is performed, so that it is possible to achieve reduction in interference without affecting main data communication.

Further, the second frequency band may be a frequency band with a wider communication possible range than a communication possible range of the first frequency band.

The second frequency band is a frequency band for sharing information among the plurality of access points, and thus is preferably a frequency band with a wider communication possible range than a communication possible range of the first frequency band. For example, the second frequency band may be a frequency band less than 5 GHz, and the first frequency band may be a frequency band equal to or higher than 5 GHz.

Note that the second control signal may be transmitted as a non-modulated signal if the second control signal can request stop of transmission of the first control signal.

The second frequency band may be a frequency band in which a third control signal for sharing information regarding the user device with other access points is transmitted.

The third control signal can be set as, for example, a signal for sharing an authentication result of the user device among the access points or a signal for sharing information regarding a target user device among the plurality of access points when handover is performed.

A specific embodiment of the present disclosure will be described below based on the drawings. A hardware configuration, a module configuration, a functional configuration, and the like, described in each embodiment are not intended to limit the technical scope of the disclosure thereto unless otherwise specified.

### First Embodiment

### Outline of System

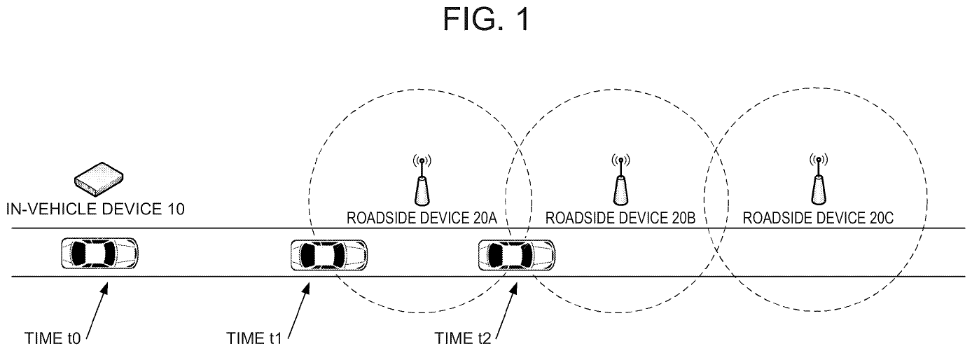

Outline of a communication system according to a first embodiment will be described with reference to FIG. 1. The communication system according to the present embodiment includes an in-vehicle device 10 mounted on a vehicle, and a plurality of roadside devices 20 provided along a road. The roadside device 20 is one example of an “access point”.

Note that while in the example in FIG. 1, roadside devices 20A, 20B, 20C are exemplified, when it is not necessary to distinguish among them, they will be collectively referred to as a “roadside device 20”.

The communication system according to the present embodiment is a system that performs wireless communication in accordance with communication procedure specified in IEEE 802.11. The plurality of roadside devices 20 has a common group address for identifying a group, and a local address specific for each device. The group may correspond to a mobility domain in the standards of IEEE 802.11.

The plurality of roadside devices 20 may belong to a common basic service set (BSS). The in-vehicle device 10 that is a user device can access one of the roadside devices 20 by utilizing a common identifier such as a group address and a BSSID and can be authenticated. The authentication result is shared among the plurality of roadside devices 20, which enables the in-vehicle device 10 to change the roadside device 20 that is a connection destination without performing authentication procedure again.

Each of the roadside devices 20A, 20B, 20C has a data communication possible range with the in-vehicle device 10 (for example, with a radius of approximately 100 meters, indicated by a dotted line in FIG. 1).

The in-vehicle device 10 can perform communication by connecting to one of the roadside devices 20 while moving. Further, the in-vehicle device 10 can switch the roadside device 20 that is a connection destination during communication.

In the Wi-Fi communication system, the access point (roadside device 20) periodically transmits a beacon frame (one example of a “first control signal” in the present disclosure) for finding the user device (in-vehicle device 10), and the user device (in-vehicle device 10) that has received this specifies the access point (roadside device 20) that is a candidate for a connection destination.

However, when the beacon frame is transmitted in a frequency band (first frequency band) that is the same as a frequency band for performing data communication, there is a case where interference may occur among the plurality of access points.

For example, when the in-vehicle device 10 performs data communication with the roadside device 20A, there is a case where a beacon frame transmitted by the roadside device 20B may reach the in-vehicle device 10. Here, when communication channels of the both are the same, a problem can occur that interference occurs, and an error rate increases or a data communication speed decreases.

Thus, in the present embodiment, each roadside device 20 transmits a signal that requests surrounding roadside devices 20 to stop transmission of the beacon frame (a “second control signal” in the present disclosure, hereinafter, referred to as a stop request signal) during execution of the data communication with the in-vehicle device 10. The roadside devices 20 that have received the signal stop periodic transmission of the beacon frame while receiving the signal. Transmission of the stop request signal ends at a timing at which the roadside device 20 that is a transmission source ends the data communication.

Further, in the communication system according to the present embodiment, each roadside device 20 is configured to be able to perform communication with the in-vehicle device 10 using two frequency bands of a first frequency band and a second frequency band, and the stop request signal is transmitted in the second frequency band.

The first frequency band is a frequency band for performing main data communication, and is typically a frequency band equal to or higher than 5 GHz, such as 5 GHz and 60 GHz. This frequency band has characteristics that high-speed data communication can be performed, but a communication possible range is relatively short from several tens to 100 meters.

The second frequency band is a frequency band for performing subordinate data communication, and is typically a frequency band of a sub 5 GHz band such as 2.4 GHz. The sub 5 GHz band has characteristics that a data communication speed is inferior to the frequency band equal to or higher than 5 GHz (for example, a 60 GHz band), but a communication possible range is several times (for example, approximately several hundreds meters) of that of the frequency band.

In the example in FIG. 1, a dotted line indicates a communication possible range of the first frequency band. A communication possible range of the second frequency band is wider than the range indicated by the dotted line.

In the present embodiment, the roadside device 20 has a function of performing data communication with the in-vehicle device 10 in the first frequency band. Further, the roadside device 20 has a function of sharing information with other roadside devices 20 by utilizing the second frequency band. A signal (third control signal in the present disclosure) to be transmitted/received in the second frequency band can be, for example, a signal for sharing the authentication result of the in-vehicle device 10 among the roadside devices or a signal for sharing information regarding the in-vehicle device 10 that is to perform handover among the plurality of roadside devices 20.

By transmitting the stop request signal by utilizing the second frequency band with a wider communication possible range than the communication possible range of the first frequency band, it is possible to request more roadside devices 20 to stop transmission of the beacon frame.

### Hardware Configuration

Hardware configurations of respective devices constituting the system will be described next.

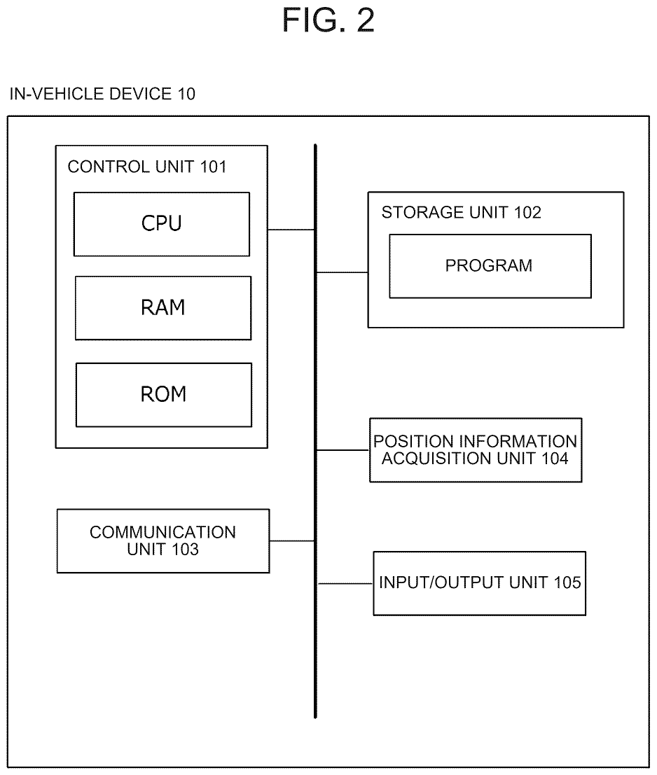

FIG. 2 is a view schematically illustrating an example of a hardware configuration of the in-vehicle device 10 that can be mounted on a vehicle.

The in-vehicle device 10 can be configured as a computer including a processor (such as a CPU and a GPU), a main storage device (such as a RAM and a ROM), an auxiliary storage device (such as an EPROM, a hard disk drive and a removable medium). In the auxiliary storage device, an operating system (OS), various programs, various tables, and the like, are stored, and by the programs stored therein being executed, respective functions (software modules) that match predetermined purposes as will be described later can be implemented. However, some or all of the functions may be, for example, implemented as hardware modules by hardware circuits such as an ASIC and an FPGA.

The in-vehicle device 10 includes a control unit 101, a storage unit 102, a communication unit 103, a position information acquisition unit 104, and an input/output unit 105.

The control unit 101 is an arithmetic unit that implements various functions of the in-vehicle device 10 by executing predetermined programs. The control unit 101 can be implemented by, for example, a hardware processor such as a CPU. Further, the control unit 101 may include a RAM, a read only memory (ROM), a cache memory, and the like.

The storage unit 102, which is means for storing information, is constituted with a storage medium such as a RAM, a magnetic disk and a flash memory. In the storage unit 102, programs to be executed at the control unit 101, data to be utilized by the programs, and the like, are stored.

The communication unit 103 is a wireless communication interface for transmitting/receiving wireless signals. The communication unit 103 is, for example, configured to be able to transmit/receive wireless signals complying with standards of a wireless LAN, and the like. Further, the communication unit 103 can transmit/receive these wireless signals in two different frequency bands. In the present embodiment, the communication unit 103 can transmit/receive the wireless signals in two frequency bands of a frequency band (first frequency band) equal to or higher than 5 GHz and a frequency band (second frequency band) less than 5 GHz.

The position information acquisition unit 104 acquires position information of a vehicle 1. The position information acquisition unit 104 includes a GPS antenna for measuring the position information and a positioning module. The GPS antenna is an antenna that receives a positioning signal transmitted from a positioning satellite (also referred to as a GNSS satellite). The positioning module is a module that calculates the position information based on a signal received by the GPS antenna. Note that the position information acquisition unit 104 may determine a traveling direction of the vehicle 1 based on transition of the position information.

The input/output unit 105 is a unit that receives an input from an occupant of the vehicle and presents information to the occupant. Specifically, the input/output unit 105 includes a touch panel and control means thereof, and a liquid crystal display and control means thereof. The touch panel and the liquid crystal display are configured as one touch panel display in the present embodiment.

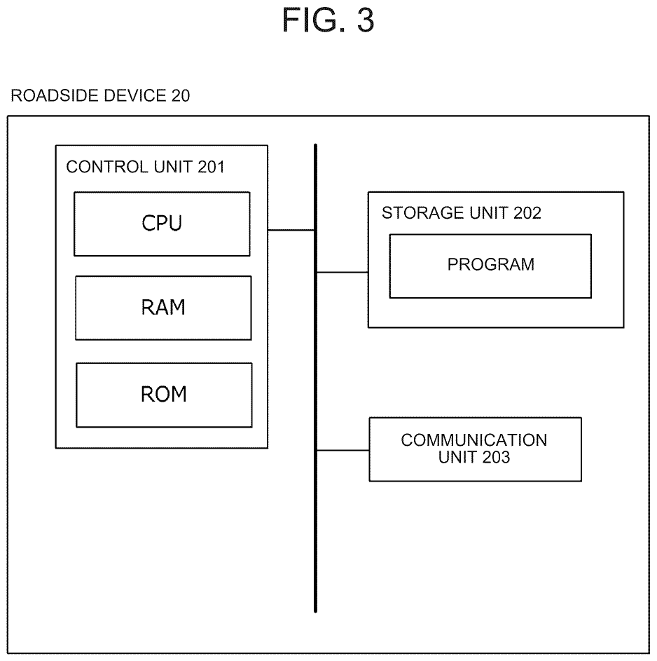

A hardware configuration of the roadside device 20 will be described next. FIG. 3 is a view schematically illustrating an example of the hardware configuration of the roadside device 20.

The roadside device 20 can be configured as a computer including a processor (such as a CPU and a GPU), a main storage device (such as a RAM and a ROM), and an auxiliary storage device (such as an EPROM, a hard disk drive and a removable medium) in a similar manner to the in-vehicle device 10.

The roadside device 20 includes a control unit 201, a storage unit 202, and a communication unit 203.

The control unit 201 is an arithmetic unit that implements various functions of the roadside device 20 by executing predetermined programs. The control unit 201 can be implemented by, for example, a hardware processor such as a CPU. Further, the control unit 201 may include a RAM, a read only memory (ROM), a cache memory, and the like.

The storage unit 202, which is means for storing information, is constituted with a storage medium such as a RAM, a magnetic disk, and a flash memory. In the storage unit 202, programs to be executed at the control unit 201, data to be utilized by the programs, and the like, are stored.

The communication unit 203 is a wireless communication interface for transmitting/receiving wireless signals with the in-vehicle device 10. The communication unit 203 is, for example, configured to be able to transmit/receive wireless signals complying with standards of a wireless LAN, or the like. The communication unit 203 can transmit/receive these wireless signals in two different frequency bands in a similar manner to the communication unit 103.

### Software Configuration

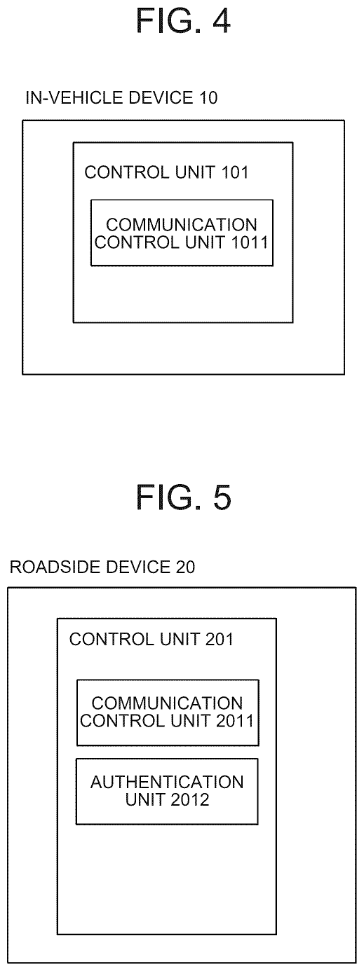

A software configuration of respective devices constituting the system will be described next. FIG. 4 is a view schematically illustrating a software configuration of the in-vehicle device 10 according to the present embodiment. A hardware configuration of the in-vehicle device 10 is as illustrated in FIG. 2.

In the present embodiment, the control unit 101 provided in the in-vehicle device 10 includes a communication control unit 1011 as a software module. The software module may be implemented by the control unit 101 (such as the CPU) executing the program stored in the storage unit 102. Note that information processing to be executed by the software module is synonymous with information processing to be executed by the control unit 101 (such as the CPU).

The communication control unit 1011 executes processing (including handover processing) of establishing a connection with one of the plurality of roadside devices 20 and transmitting/receiving data.

The communication control unit 1011 first executes a step of detecting existence of the roadside device 20 included in the communication system and requesting a connection to the communication system. In the present step, the communication control unit 1011 receives a beacon frame transmitted from the roadside device 20 and executes procedure for authentication using authentication information stored in advance in response to this. The authentication information is, for example, an identifier for uniquely identifying the in-vehicle device 10, a key to be utilized when the in-vehicle device 10 is connected to the communication system, an electronic certificate, or the like. Note that the authentication information stored in the in-vehicle device 10 may be different from the authentication information to be transmitted to the roadside device 20. For example, when a private key is stored in the in-vehicle device 10, a hash, or the like, generated based on the private key may be transmitted to the roadside device 20. By this means, a connection between the in-vehicle device 10 and the communication system is established.

Second, the communication control unit 1011 executes transmission/reception of data between the in-vehicle device 10 and the roadside device 20 and executes switching (handover) of a connection destination with other roadside devices 20 as necessary.

A specific control method will be described later.

A software configuration of the roadside device 20 will be described next. FIG. 5 is a view schematically illustrating the software configuration of the roadside device 20 according to the present embodiment. A hardware configuration of the roadside device 20 is as illustrated in FIG. 3.

In the present embodiment, the control unit 201 provided in the roadside device 20 includes two software modules of a communication control unit 2011 and an authentication unit 2012. The respective software modules may be implemented by the control unit 201 (such as the CPU) executing the program stored in the storage unit 202. Note that information processing to be executed by the software module is synonymous with information processing to be executed by the control unit 201 (such as the CPU).

The communication control unit 2011 performs data communication with the in-vehicle device 10. Specifically, the communication control unit 2011 performs the following processing.

(1) Processing of Broadcast Transmitting a signal for Finding the In-Vehicle Device 10 and Executing Authentication Based on a Request From the In-Vehicle Device 10

The communication control unit 2011 periodically broadcast transmits a beacon frame for finding the in-vehicle device 10. When there is a response from the in-vehicle device 10, the communication control unit 2011 performs a handshake including authentication processing with the in-vehicle device 10. The authentication processing is performed by the authentication unit 2012 which will be described later. Note that when the authentication result of the target in-vehicle device 10 has been already received from other roadside devices 20, the authentication processing is omitted (described later). Transmission of the beacon frame and the authentication processing are performed by utilizing a first frequency band.

### (2) Processing of Performing Data Communication With the In-Vehicle Device 10

When a handshake with the in-vehicle device 10 is completed, the communication control unit 2011 starts data communication with the in-vehicle device 10. The data communication is performed in the first frequency band. The data communication may be performed by, for example, transmission of a plurality of data blocks and reception of a block Ack being repeated.

Further, the communication control unit 2011 has a function of controlling handover among the plurality of roadside devices 20. For example, the communication control unit 2011 determines to switch (hand over) a connection destination of the in-vehicle device 10 to another roadside device 20 based on a communication situation of the in-vehicle device 10. For example, the communication control unit 2011 determines another roadside device 20 that becomes a new connection destination of the in-vehicle device 10 and transmits information regarding the roadside device 20 to the in-vehicle device 10. The information includes information regarding the roadside device 20 that becomes a candidate for the connection destination, and the like. The information is transmitted by utilizing the first frequency band. The in-vehicle device 10 can switch the roadside device 20 that is the connection destination by utilizing the information. Further, the communication control unit 2011 transmits information regarding the in-vehicle device 10 to another roadside device 20 that becomes a candidate for a handover destination. The information is transmitted by utilizing the second frequency band.

Further, the communication control unit 2011 successively transmits a stop request signal by utilizing the second frequency band during data communication with the in-vehicle device 10. The stop request signal may be broadcast transmitted or may be unicast transmitted to other roadside devices 20 that may cause interference.

The communication control unit 2011 ends transmission of the stop request signal at a timing at which the data communication between the own device and the in-vehicle device 10 ends.

Note that the communication control unit 2011 stops transmission of the beacon frame described above during a period while the stop request signal is being received from other roadside devices 20.

The authentication unit 2012 performs authentication of the in-vehicle device 10 based on a request from the communication control unit 2011. The authentication unit 2012 may perform authentication, for example, using a pre-shared key (PSK). In this case, the authentication information is a key generated based on a passphrase. Further, the authentication unit 2012 may perform, for example, IEEE 802.1x authentication. In this case, the authentication information is a combination of a user name and a password or an electronic certificate.

Further, when authentication of the in-vehicle device 10 is successful, the authentication unit 2012 transmits a result of the authentication to other roadside devices 20 belonging to the same communication system. The information is transmitted by utilizing the second frequency band. This enables other roadside devices 20 to continue communication without performing authentication again when a handover occurs.

### Processing Flowchart

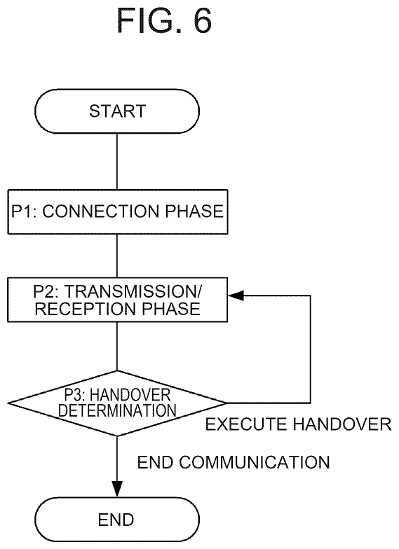

Flow of processing in communication will be described next. FIG. 6 is a view for explaining phases of processing to be executed by the in-vehicle device 10 and the roadside device 20 according to the present embodiment. In the present example, description will be provided assuming a case where a vehicle equipped with the in-vehicle device 10 is traveling on a road on which a plurality of roadside devices 20 is arranged.

A first phase (P1) is a phase (connection phase) in which the in-vehicle device 10 recognizes existence of the roadside device 20 and performs a handshake with the communication system. In the connection phase, the in-vehicle device 10 receives a beacon frame transmitted from the roadside device 20 and requests a handshake to the communication system in response to this. The handshake is performed after transmission of a probe request, transmission of an authentication request, transmission of an association request, and the like. These kinds of data are transmitted in the first frequency band. The roadside device 20 that has received the request for a handshake from the in-vehicle device 10 establishes a connection with the in-vehicle device 10 and executes authentication of the in-vehicle device 10. The authentication result is shared among a plurality of other roadside devices 20 included in the communication system via the second frequency band.

Each of the plurality of roadside devices 20 can recognize that the in-vehicle device 10 has been authenticated by the communication system based on the acquired authentication result.

The next phase (P2) is a phase (transmission/reception phase) in which the in-vehicle device 10 and the roadside device 20 transmit/receive data.

When a connection between the in-vehicle device 10 and the roadside device 20 is established, and authentication of the in-vehicle device 10 is completed, data communication is started between the in-vehicle device 10 and the roadside device 20. In the transmission/reception phase, for example, transmission of a plurality of data blocks and reception of a block Ack may be repeatedly performed.

In the transmission/reception phase, if a predetermined condition is satisfied, the phase transitions to a phase in which handover is determined. The predetermined condition may be, for example, a condition that communication quality between the in-vehicle device 10 and the roadside device 20 falls below a predetermined value, or the like.

In the phase (P3) in which handover is determined, the roadside device 20 that is performing communication with the in-vehicle device 10 determines that there is another roadside device 20 to which handover is possible. When handover is possible, the roadside device 20 transmits information regarding the other roadside device 20 that becomes a candidate for the handover destination to the in-vehicle device 10, and the in-vehicle device 10 switches the connection destination. When there is no roadside device 20 to which handover is possible, communication ends.

Next, processing to be executed by each device in each phase described above will be specifically described.

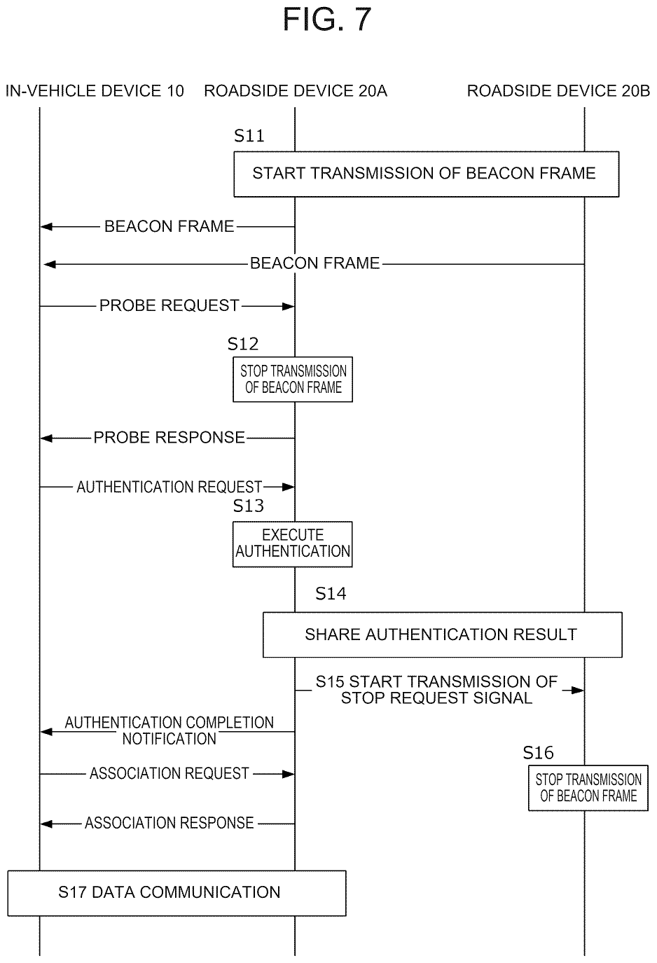

FIG. 7 is a sequence diagram of data to be transmitted/received between the in-vehicle device 10 and the roadside device 20 in the connection phase and the transmission/reception phase. Note that in the present example, an access point with which the in-vehicle device 10 performs communication first is set as a roadside device 20A, and an access point that becomes the handover destination is set as a roadside device 20B.

First, the roadside devices 20A and 20B start periodic transmission of a beacon frame. The beacon frame is data to be broadcast transmitted in the first frequency band by the roadside device 20 to make a notification of existence of the own device.

When the in-vehicle device 10 receives the beacon frame from the roadside device 20, the in-vehicle device 10 starts procedure for connecting to the roadside device 20.

The beacon frame includes an identifier of the roadside device 20, and the in-vehicle device 10 transmits a probe request including the identifier of the roadside device 20 to which the in-vehicle device 10 desires to be connected, to the roadside device 20.

Note that when the beacon frame is received from a plurality of roadside devices 20, the in-vehicle device 10 may select the roadside device 20 with the strongest signal intensity. It is assumed here that the in-vehicle device 10 selects the roadside device 20A as the connection destination and transmits a probe request to the roadside device 20A.

When the roadside device 20A receives the probe request addressed to the own device, the roadside device 20A stops transmission of the beacon frame (step S12) and transmits a probe response including network information of the own device, and the like, to the in-vehicle device 10.

The in-vehicle device 10 that has received the probe response transmits an authentication request that requests authentication to the roadside device 20A. The authentication request may include authentication information (such as key information) held by the in-vehicle device 10.

When the roadside device 20A receives the authentication request, the processing transitions to a step (step S13) of executing authentication of the in-vehicle device 10. In step S13, the roadside device 20A (authentication unit 2012) authenticates the in-vehicle device 10 based on the authentication information received from the in-vehicle device 10. The authentication may be performed using, for example, pre-shared key (PSK), or IEEE 802.1x.

When the authentication of the in-vehicle device 10 is completed, the roadside device 20A executes processing of sharing a result of the authentication with other roadside devices 20 included in the communication system (step S14). For example, the roadside device 20A (authentication unit 2012) transmits the result of the authentication executed in step S13 to the roadside device 20B belonging to the same communication system (for example, the roadside device 20B having the same group address as the group address of the roadside device 20A). This eliminates the need for each roadside device 20 to individually authenticate the in-vehicle device 10.

Note that when the authentication unit 2012 has already received sharing of the authentication result for the target in-vehicle device 10 from other roadside devices 20, the authentication processing is skipped.

Then, the roadside device 20A starts broadcast transmission of a signal (stop request signal) requesting stop of transmission of the beacon frame (step S15). The stop request signal is successively transmitted until a stop timing arrives. The stop request signal may be a non-modulated signal (for example, a pulse signal having a specified pulse width). The roadside device 20B that has received the stop request signal stops periodic transmission of the beacon frame until the successively transmitted stop request signal is interrupted (step S16).

The authentication result and the stop request signal described above are transmitted via the second frequency band.

The second frequency band is a frequency band lower than the frequency band (first frequency band) for performing main data communication. Typically, if a frequency of a radio wave becomes lower, a communication possible range becomes wider due to diffraction attenuation characteristics. Thus, the roadside device 20A can cause the roadside device 20B to stop transmission of the beacon frame at a timing before the in-vehicle device 10 enters a communication possible range using the first frequency band of the roadside device 20B.

When the processing described above is completed, the roadside device 20A transmits a notification (authentication completion notification) indicating that authentication has been completed to the in-vehicle device 10.

When the authentication is completed, the in-vehicle device 10 transmits an association request to the roadside device 20A, and the roadside device 20A transmits an association response to the in-vehicle device 10. Note that procedure for encrypted communication may be additionally performed. Through the processing described above, the handshake between the in-vehicle device 10 and the communication system is completed.

When the handshake between the in-vehicle device 10 and the communication system is completed, data communication is started in step S17. The data communication may be, for example, transmission of data collected at the vehicle from the in-vehicle device 10 to the roadside device 20A. The data communication may be performed by transmission of a plurality of data blocks and reception of a block Ack being repeated.

Note that the order of part of the processing indicated in FIG. 7 may be changed. For example, the processing (processing of starting transmission of the stop request signal) in step S15 may be performed at an arbitrary timing before the processing in step 17 is executed.

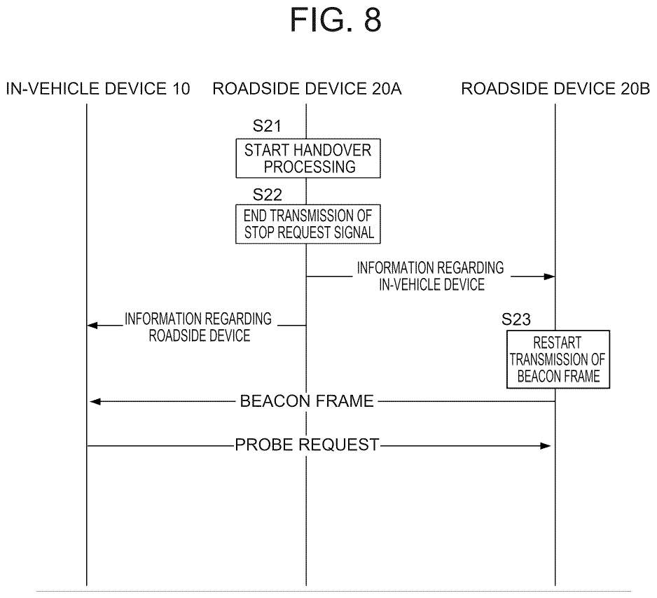

FIG. 8 is a sequence diagram of data to be transmitted/received between the in-vehicle device 10 and the roadside device 20 in the handover phase. The indicated processing is started at a timing at which the roadside device 20A determines to handover communication from the in-vehicle device 10 to another roadside device 20B. Whether or not to perform handover can be determined based on, for example, the position information of the in-vehicle device 10, electric field intensity of a radio wave, a communication error rate, and the like.

First, in step S21, the communication control unit 2011 starts handover processing. In this step, for example, the roadside device (in the present example, the roadside device 20B) that is a candidate for an access point (handover destination) to which the in-vehicle device 10 is to be connected next is determined based on, for example, information regarding movement of the in-vehicle device 10, the position information of the in-vehicle device 10, position information of other roadside devices 20, and the like. Note that there is a plurality of candidates for the roadside device.

When the roadside device that becomes a candidate for the handover destination is determined, the communication control unit 2011 of the roadside device 20A ends transmission of the stop request signal that has been continued from step S15 (step S22). The roadside device 20B that has detected this restarts transmission of the beacon frame (step S23).

Further, the communication control unit 2011 of the roadside device 20A transmits information regarding the target in-vehicle device 10 to the communication control unit 2011 of the roadside device 20B in the second frequency band. The information may include the identifier of the in-vehicle device 10, a movement situation, and the like.

Further, the communication control unit 2011 of the roadside device 20A transmits information regarding the roadside device that is a candidate for the handover destination to the in-vehicle device 10. This enables the in-vehicle device 10 to recognize the roadside device 20 to which the in-vehicle device 10 is to be connected next.

When the in-vehicle device 10 is notified of the identifier of the roadside device 20B as the roadside device that is the handover destination, the in-vehicle device 10 responds to the beacon frame transmitted from the roadside device 20B and starts connection with the roadside device 20B. Note that when there is a plurality of candidates for the roadside device that is the handover destination, the in-vehicle device 10 may determine the roadside device 20 to which the in-vehicle device 10 is to be connected next based on a radio wave condition, and the like.

A series of connection procedure starting from reception of the beacon frame is as described with reference to FIG. 7. Note that when the authentication result of the in-vehicle device 10 is shared in advance, the authentication processing is omitted, and communication is immediately started.

As described above, the roadside device 20 according to the first embodiment requests the roadside device 20 in the vicinity to stop transmission of the beacon frame by utilizing the second frequency band during communication with the in-vehicle device 10 by utilizing the first frequency band.

According to such a configuration, it is possible to avoid interference of a frame for data communication and a frame for control between the roadside devices that are close to each other, so that it is possible to implement higher-speed and higher-reliable data communication.

### Modification

The above-described embodiment is merely one example, and the present disclosure can be changed as appropriate and implemented within the scope not deviating from the gist of the present disclosure.

For example, the processing and the means described in the present disclosure can be freely combined unless technical inconsistency arises.

Further, while an example has been described in the embodiment where the authentication result of the in-vehicle device 10 and the information for handover are shared among the plurality of roadside devices by utilizing the second frequency, other kinds of information regarding the in-vehicle device 10 may be shared by utilizing the second frequency. Examples of such information can include, for example, the position information, attribute information, information regarding a speed, a moving direction of the in-vehicle device 10, and the like.

Further, while an example has been described in the embodiment where data is transmitted (uploaded) from the in-vehicle device 10 to the communication system, a direction of communication is not limited to this. Data can be transmitted from the communication system to the in-vehicle device 10, and data may be freely transmitted/received within a communication possible period.

Further, while in the embodiment, the second frequency band is set as a frequency band less than 5 GHz, and the first frequency band is set as a frequency band equal to or higher than 5 GHz, other frequency bands may be utilized.

Further, while an example has been described in the embodiment where the beacon frame (first control signal) is transmitted in the first frequency band, and the stop request signal (second control signal) is transmitted in the second frequency band, the respective signals do not necessarily have to be transmitted in different frequency bands (such as, for example, a megahertz band and a gigahertz band, a 2.4 GHz band and a 5 GHz band) if the signals are transmitted in different frequencies. For example, the respective signals may be transmitted in different channels in a wireless LAN.

Further, modulation schemes, bit rates, and the like, may be different between a signal to be transmitted in the first frequency band and a signal to be transmitted in the second frequency band. The modulation schemes and the bit rates can be set such that a range in which the signal to be transmitted in the second frequency band can reach becomes wider than a range in which the signal to be transmitted in the first frequency band can reach.

Further, while an example has been described in the embodiment where the authentication result of the in-vehicle device 10 is transmitted from the roadside device 20A to the roadside device 20B, three or more roadside devices may relay the received information from one another. This makes it possible to share information regarding the in-vehicle device 10 among all the roadside devices 20 included in the communication system.

Further, while in the embodiment, each roadside device 20 performs authentication of the in-vehicle device 10, the authentication of the in-vehicle device 10 may be performed by an external authentication server. In this case, the authentication server and each roadside device 20 may perform communication in a wireless manner or in a wired manner. Also in this case, the authentication result of the in-vehicle device 10 is shared among all the roadside devices 20 included in the communication system.

The processing that has been described as being performed by one device may be divided among and executed by a plurality of devices. Or the processing that has been described as being performed by different devices may be executed by one device. In the computer system, by what hardware component (server component) each function is implemented can be flexibly changed.

The present disclosure can also be implemented by supplying a computer program provided with the functions described in the above-described embodiment to a computer, and causing one or more processors belonging to that computer to read and execute the program. Such a computer program may be provided to the computer by a non-transitory computer-readable storage medium that can be connected to a system bus of the computer, or may be provided to the computer via a network. Examples of the non-transitory computer-readable storage media include arbitrary types of discs such as magnetic discs (floppy (registered trademark) discs, hard disc drives (HDDs), etc.) and optical discs (CD-ROMs, DVD discs, Blu-ray discs, etc.), read-only memories (ROMs), random-access memories (RAMs), EPROMs, EEPROMs, magnetic cards, flash memories, optical cards, and arbitrary types of media suitable for storing electronic commands.

What is claimed is:

1. A communication method to be executed by a first access point included in a plurality of access points in a communication system in which a user device is configured to perform communication with the plurality of access points, the user device being a moving user device, the communication method comprising:
transmitting a first control signal for controlling communication with the user device in a first frequency band;
performing data communication with the user device in the first frequency band; and
transmitting, in a second frequency band during the data communication with the user device, a second control signal which is a signal requesting one or more other access points to stop transmission of the first control signal.

2. The communication method according to claim 1, wherein the first access point is configured to successively transmit the second control signal during the data communication with the user device.

3. The communication method according to claim 1, further comprising stopping the transmission of the first control signal when the first access point receives the second control signal transmitted from one or more other access points, wherein the first control signal includes a signal to be periodically transmitted to find the user device.

4. The communication method according to claim 1, wherein the second frequency band is a frequency band with a wider communication possible range than a communication possible range of the first frequency band.

5. The communication method according to claim 1, wherein the second control signal is a non-modulated signal.

6. The communication method according to claim 1, wherein:
the communication system is a communication system in which handover is possible; and
the second frequency band is a frequency band for sharing information regarding the user device targeted for the handover with one or more other access points belonging to the same group.

7. The communication method according to claim 1, further comprising transmitting a third control signal which is a signal for sharing information regarding the user device targeted for handover with one or more other access points, in the second frequency band, wherein the communication system is a communication system in which the handover is possible.

8. A communication device functioning as a first access point in a communication system in which a user device is configured to perform communication with a plurality of access points, the user device being a moving user device, the communication device comprising a control unit configured to:
transmit a first control signal for controlling communication with the user device in a first frequency band;
perform data communication with the user device in the first frequency band; and
transmit, in a second frequency band during the data communication with the user device, a second control signal which is a signal requesting one or more other access points to stop transmission of the first control signal.

9. The communication device according to claim 8, wherein the control unit is configured to successively transmit the second control signal during the data communication with the user device.

10. The communication device according to claim 8, wherein:
the first control signal includes a signal to be periodically transmitted to find the user device; and
the control unit is configured to stop the transmission of the first control signal when the second control signal transmitted from one or more other access points is being received.

11. The communication device according to claim 8, wherein the second frequency band is a frequency band with a wider communication possible range than a communication possible range of the first frequency band.

12. The communication device according to claim 8, wherein the second control signal is a non-modulated signal.

13. The communication device according to claim 8, wherein:
the communication system is a communication system in which handover is possible; and
the second frequency band is a frequency band for sharing information regarding the user device targeted for the handover with one or more other access points belonging to the same group.

14. The communication device according to claim 8, wherein:
the communication system is a communication system in which handover is possible; and
the control unit is configured to transmit a third control signal which is a signal for sharing information regarding the user device targeted for the handover with one or more other access points, in the second frequency band.
